(19) United States
(12) Patent Application Publication
(10) Pub. No.: US 2020/0124501 A1
(43) Pub. Date: Apr. 23, 2020

(54) Collision Target Dummy

(71) Applicant: Humanetics Austria GmbH, Linz (AT)

(72) Inventor: Markus Schmidl, Kematen an der Ybbs (AT)

(21) Appl. No.: 16/655,442

(22) Filed: Oct. 17, 2019

(30) Foreign Application Priority Data
Oct. 18, 2018 (DE) 102018125823.2

(51) Int. Cl. G01M 17/007

(52) U.S. Cl. CPC G01M 17/0078

(57) ABSTRACT

The invention relates to a soft collision target for trials with a possible vehicle collision having a support structure and having at least one covering panel releasably connected to the support structure, said covering panel replicating an outer shape of a collision target, with said covering panel consisting of a composite material that comprises a first layer forming the outer side and a second layer carrying it.

The present invention relates to a soft collision target for trials with a possible vehicle collision having a support structure and having at least one covering panel that is releasably connected to the support structure and that replicates an outer shape of a collision target.

Soft collision targets are typically used in vehicle collision trials to recreate a traffic participant such as a further vehicle by the shape of the covering of the support structure. To represent a realistic traffic scenario with moving traffic, the soft collision targets are configured as movable so that the soft collision targets can be traveled. The soft collision target is here fastened by means of a hook and loop connection to a soft collision target carrier or to a covering panel at a support structure disposed thereunder, Higher speeds, e.g. above 100 km/h, currently have the consequence of a releasing of the soft collision target from the soft target carrier or of the covering from the support structure. To avoid collision damage, current soft targets are produced from a soft foam of little shape stability. A realistic appearance of the soft collision target is not given,

Particularly as part of the increasing automation of the propulsion of vehicles, a realistic appearance of the soft collision target is of great importance to test the sensor system for estimating the traffic situation and a correct response of the driving assistance systems under conditions that are as realistic as possible, in particular at high speeds.

It is therefore an object of the invention to provide a soft collision target that also provides a realistic appearance at higher speeds and by means of which any collision damage can simultaneously be avoided or can at least be reduced to a small amount.

The object is satisfied in each case by a soft collision target having the features of independent claims 1 and 9.

In accordance with claim 1, the invention relates to ja soft collision target for trials with a possible vehicle collision having a support structure and having at least one covering panel releasably connected to the support structure, said covering panel replicating an outer shape of a collision target, with said covering panel consisting of a composite material that comprises a first layer forming an outer side and a second layer carrying it.

In accordance with claim 9, the invention relates to a soft collision target for trials with a possible vehicle collision, having a support structure and at least one covering panel releasably connected to the support structure, said covering panel replicating an outer shape of a collision target, wherein the carrier structure has a plurality of struts of which at least one strut comprises at least two strut members arranged following one another in their longitudinal direction and braced against one another by an elastic tensioning means at their ends that face one another.

It is the underlying idea of the invention that a soft collision target has a more realistic appearance and is simultaneously more stable at higher speeds when a covering panel of the soft collision target consists of a composite material having a first layer and a second layer. The first layer that forms an outer side of the covering panel or of the soft collision target here satisfies the purpose of imitating a shape of an object to be replicated as exactly as possible, whereas the second layer serves to carry the first layer, whereby the stability of the covering panel is increased overall. The releasable connection between the support structure and the covering panel moreover contributes to the covering panel being able to be released from the support structure on a collision, whereby no or little resistance is opposed to a vehicle colliding with the soft collision target. Collision damage to the soft collision target and to the vehicle can hereby be avoided or at least reduced.

It is also the idea underlying the invention that collision damage can additionally be avoided or reduced in that a support structure of the soft collision target to which at least one covering panel is releasably attached has a plurality of struts of which at least one strut comprises at least two strut members that are arranged after one another in their longitudinal direction and are mutually braced by elastic tensioning means at their ends that face one another. The ends of the strut members that face one another here form a kink point at which the support structure can directly yield on a collision so that the soft collision target opposes no resistance or at most little resistance to the vehicle and collision damage is avoided or reduced. The elastic tensioning means does not only serve to brace the at least two strut members with such force transmission that they form a stable strut of the support structure, but also makes it possible that the kinked struts straighten up again independently after a collision. It is understood that the at least one covering panel can be released from the support structure on a collision due to said covering panel's releasable connection to said support structure, whereby additional collision damage can be avoided or at least reduced. Furthermore, a design is made possible by the configuration of the support structure with struts by which design the support structure and the covering panel can be matched to one another such that a realistic appearance of the soft collision target results overall.

The advantage results from the realistic appearance and from the higher stability of the soft collision target even at high speeds that the behavior of an autonomously driving vehicle can be examined under even more realistic conditions. A possible erratic behavior of the vehicle can hereby be recognized in good time and improvements can be made, which has a positive effect on the safety of the vehicle. Since the soft collision target does not oppose any resistance or only a little resistance to a vehicle colliding with it, the advantage additionally results that no damage or no real damage arises at the vehicle and at the soft collision target.

The soft collision target cannot only be used in connection with autonomously driving vehicles, but can also be used when soft collision targets are used to simulate a realistic traffic scene, e.g. driving safety training.

A soft collision target is a realistic replica of a real vehicle, of a person or the like. Unlike with the vehicle to be simulated, it is an advantage of a soft collision target that a component of the soft collision target such as a covering panel possibly damaged on a collision with the soft collision target can be replaced simply and inexpensively with a comparatively small effort. The soft collision target is in particular suitable for multiple collision trials and in this respect preferably has a flawless and above all realistic appearance.

Advantageous embodiments of the invention can be seen from the dependent claims, from the description, and from the drawings.

A particularly stable and light construction of the covering panel is possible when the first layer is thinner than the second layer and comprises a harder material with respect to the second layer. The material which the first layer comprises is preferably denser than the material of the second layer. Unlike a covering panel from foam, a comparatively dense first layer that forms an outer side enables a similar surface property as with a real vehicle. The first layer can moreover be painted or colored as with a real vehicle, whereby the covering panel gives the soft collision target an even more realistic appearance. Light reflections on a shiny surface of the first layer are in particular comparable with such light reflections of a surface of a real vehicle so that a simulated traffic scene is even more realistic.

So that the outer side of the covering panel is particularly stable, the first layer can comprise a plastic material, in particular polycarbonate. A contribution is made to an additional increase of the stability if the second layer carrying the first layer is formed from a foamable material, which additionally enables a lighter construction of the covering panel. The foamable material can in particular be a foamable plastic material and preferably a polyurethane foam. It is, however, also conceivable that the foamable material is a different plastic material such as polystyrene.

To give the covering panel a realistic appearance, the shape of the first layer can take place in a simple manner by a deep drawing process.

A contribution is further made to the stability of the soft collision target in that the shape of the outer side of the second layer is matched to the shape of the inner side of the first layer and in that the shape of the inner side of the second layer is adapted to the shape of the facing outer side of the support structure. In the installed state of the soft collision target, a space between the first layer and the support structure is ideally fully filled with the material of the second layer, whereby a relative movement of the covering panel with respect to the support structure can be avoided.

The covering panel is preferably attached to the support structure by means of at least one magnet. Such a magnetic connection permits a particularly stable attachment of the covering panel to the support structure. At the same time, the magnetic attachment of the covering panel to the support structure makes it possible that the covering panel can be easily released from the support structure on an increased force effect such as on a collision. The at least one magnet can, for example, be a permanent magnet and/or an electromagnet.

A particularly realistic replica of a real vehicle can be achieved in that a plurality of covering panels together form an outer cover of the soft collision target. It is moreover conceivable that further elements typical of the vehicle can be molded or attached to at least one covering panel. A covering panel can thus, for example, have a replica of a bumper. It is also possible that the covering panel is provided with vehicle lighting.

The strut members of the support structure struts can be hollow in the interior, whereby the weight of the support structure can be kept low and the elastic tensioning means can extend in the interior of the strut members, whereby the tensioning means is protected during a collision of a vehicle with the soft collision target. In this respect, a maximum bracing force of the tensioning means can be reached in that the tensioning means is respectively fastened to one of the ends of the strut members that face away from one another. It is understood that the tensioning means can, however, also be fastened to a different point at the strut members than at the ends of the strut members that face away from one another.

The strut members of a strut cannot only be connected to one another in a force transmitting manner by the tensioning means, but also with shape matching in that one respective end of the ends of the strut members that face one another comprises an elevated portion and the other end has a recess complementary to the elevated portion. A kinking at the kink point can in particular be facilitated on a collision when the elevated portion is designed in the manner of a dome and the recess is designed complementary to the dome-like elevated portion.

It is advantageous here if the elevated portion and the recess each have a passage for the elastic tensioning means extending in the longitudinal direction of the strut.

For an additional increase in the stability of the strut having at least two mutually braced strut members, the at least two mutually braced strut members can be magnetically connected to one another at their ends that face one another. In this respect, the magnetic connection can be effected in that in each case both ends of the ends of the struts that face one another have a magnet and the magnets attract one another. Permanent magnets and/or electromagnets can, for example, be used to connect the strut members. It is understood that also only one strut member can have a magnet, whereas the other strut member can comprise a magnetizable material such as a ferromagnetic material or a ferrimagnetic material.

The invention will be described in the following purely by way of example with reference to a possible embodiment and to the enclosed drawings. There are shown:

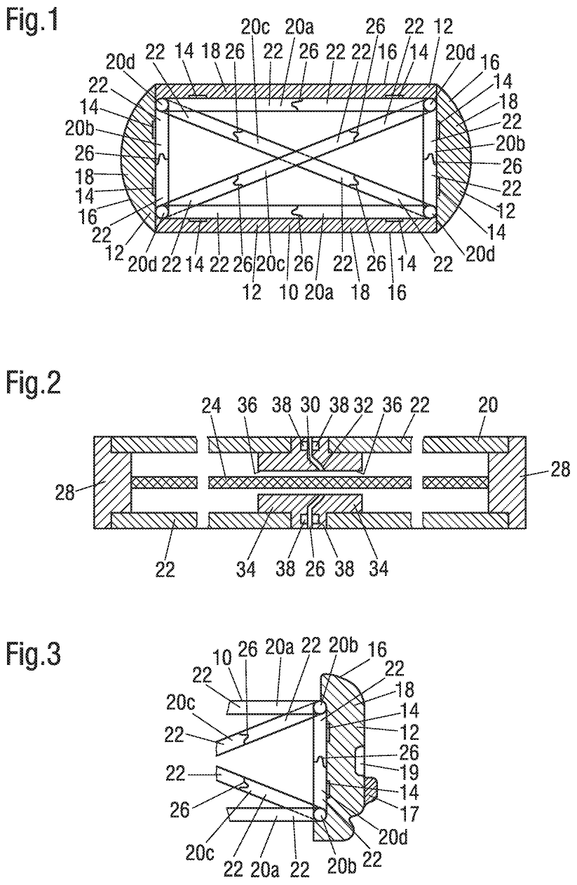

FIG. 1 a horizontal section through a soft collision target with a support structure and covering panels connected thereto;

FIG. 2 a longitudinal section through a strut of the support structure of FIG. 1; and

FIG. 3 a vertical section through a part of a variant of he soft collision target in accordance with the invention.

FIG. 1 shows a soft collision target for trials with a possible vehicle collision having a support structure 10 and having a plurality of covering panels 12 that are releasably connected to the support structure 10 and that together form an outer cover of the soft collision target. The soft collision target here forms the outer shape of a collision target, here of a motor vehicle. However, the shape of other vehicles such as a truck or a motorcycle can also be replicated using the covering panels 12.

The covering panels 12 are attached to the support structure 10 by means of a plurality of magnets 14 that can be designed in the form of permanent magnets. In the embodiment shown in FIG. 1, two respective magnets 14 are specifically associated with each covering panel 12. It is understood that a covering panel 12 can also be attached to the support structure 10 only by means of one magnet 14 or also by means of more than two magnets 14. The covering panels 12 can be released by the magnetic attachment of the covering panels 12 to the support structure 10 on a collision of a vehicle with the soft collision target, whereby collision damage can be avoided or reduced.

Each of the covering panels 12 shown in FIG. 1 consists of a composite material having a first layer 16 and a second layer 18. The first layer 18 forms an outer side of the covering pane, 12, whereas the second layer 18 serves to carry the first layer 16 in a supporting manner. The first layer 16 is here thinner than the second layer 18 and comprises a material that is harder with respect to the second layer 18. The first layer 16 preferably comprises a plastic material, in particular polycarbonate. In contrast, the second layer 18 is formed from a foamable material, in particular a foamable plastic material, and has a density that is smaller in comparison with the first layer 16. The foamable plastic material is preferably a polyurethane foam.

It can be recognized with reference to FIG. 1 that the shape of the outer side of the second layer 18 is matched to the shape of the inner side of the first layer 16. In addition, the shape of the inner side of the second layer 18 is matched to the shape of the facing outer side of the support structure 10.

The weight of the covering panels 12 can be reduced by the smaller density of the second layer 18. At the same time, the second layer 18 carries the comparatively thinner first layer 16, whereby the covering panel 12 is provided with a higher stability overall. The stability of the covering panel 12 is also in particular maintained at higher speeds, e.g. above 100 km/h.

So that the soft collision target reproduces an appearance of a vehicle that is as realistic as possible, it is necessary that the shape of the first layer 16 corresponds to the shape of the vehicle to be replicated. The shape of the first layer 16 can here be configured in a simple manner by a deep drawing method. A contribution is additionally made to a realistic appearance in that the first layer 16 has a smoother and thus more realistic surface in comparison with a foam layer.

As can be recognized with respect to FIG. 3, the covering panel 12 has further elements typical for a vehicle for an even more realistic appearance of the soft collision target. The covering panel 12 is thus provided with a replica of a bumper 17 and of vehicle lighting 19.

The support structure 10 shown in FIG. 1 is of parallelepiped design and comprises a plurality of struts 20. Two longitudinal struts 20a, two transverse struts 20b, two diagonal struts 20c, and four vertical struts 20d can be seen in FIG. 1. Each of the struts 20 of the support structure 10 comprises at least two strut members 22 arranged following one another in the longitudinal direction of the respective strut 20. As can be recognized purely by way of example with reference to FIG. 1, the longitudinal struts 20a and the transverse struts 20c each comprise two strut members 22, whereas the diagonal struts 20c each have three strut members 22. The vertical struts 20d equally also have two strut members 22 (FIG. 3).

A longitudinal sectional view of a strut 20 having two strut members 22 is shown for a more illustrative representation in FIG. 2, with the gap between two ends of the two strut members 22 that face one another being shown exaggeratedly large. In fact, the ends of the strut members 22 that face one another are braced against one another in a shape-matched and/or force-transmitting manner by means of an elastic tensioning means 24. The ends of the strut members 22 that face one another here form a kink point 26 that can yield on a collision of a vehicle with the soft collision target.

As can be recognized with reference to FIG. 2, the strut members 22 are configured in the manner of tubes, i.e. they are hollow in the interior, with the elastic tensioning means 24 extending in the interior of the strut members 22. The elastic tensioning means 24 is fastened in each case at its ends to one of the ends of the strut members 22 that face away from one another. T-shaped plugs 28 to which a respective one end of the elastic tensioning means 24 is fastened are inserted for this purpose into the ends of the strut members that face away from one another. It must be noted that the plugs 28 can also be configured such that further ends of other struts 20 can be attached so that the plugs 28 form corner regions of the support structure 10.

So that a strut can be kinked more easily in the event of a collision, one end of the ends of the strut members 22 that face one another has an elevated portion 30 that dips into a complementary recess 32 of the other end of the ends that face one another in the connected, i.e. non-kinked, state. Both the elevated portion 30 and the recess 32 are each formed at a plug 34 that is inserted into the associated strut member 22 at one of the ends that face one another. Both plugs 34 each have a passage 36 for the tensioning means 24 so that the elevated portion 30 and the recess 32 also each have a passage 36 extending in the longitudinal direction of the strut 20 for the elastic tensioning means 24.

The two strut members 22 of the strut 20 that are braced against one another are additionally magnetically connected to one another at their ends that face one another, which contributes to an increase in the stability of the connection between the two strut members 22. For this purpose, the two ends of the ends of the strut members 22 that face one another each have at least one magnet 38 and said magnets 38 attract one another. The magnets 38 are preferably permanent magnets. In the embodiment shown in FIG. 2, each end of the ends of the strut members 22 that face one another has two respective magnets 38.

A soft collision target is provided overall which also has a realistic appearance at high speeds and by means of which at the same time any collision damage can be avoided or at least reduced.

### REFERENCE NUMERAL LIST

10 support structure

12 covering panel

14 magnet

16 first layer

17 bumper

18 second layer

19 lighting

20 strut

20a longitudinal strut

20b transverse strut

20c diagonal strut

20d vertical strut

22 strut member

24 tensioning means

26 kink point

28 plug

30 elevated portion

32 recess

34 plug

36 passage

38 magnet

1. A soft collision target for trials with a possible vehicle collision comprising:
a support structure; and
at least one covering panel that is releasably connected to the support structure for replicating an outer shape of a collision target,
wherein the covering panel is a composite material that comprises a first layer forming an outer side and a second layer carrying the first layer.

2. A soft collision target in accordance with claim 1,
wherein the first layer is thinner than the second layer and comprises a material that is harder with respect to the second layer.

3. A soft collision target in accordance with claim 1,
wherein the first layer comprises a plastic material.

4. A soft collision target in accordance with claim 1,
wherein the second layer is formed from a foamable material.

5. A soft collision target in accordance claim 1,
wherein the shape of the first layer takes place by a deep drawing process.

6. A soft collision target in accordance with claim 1,
wherein the shape of an outer side of the second layer is matched to the shape of an inner side of the first layer; and wherein the shape of an inner side of the second layer is adapted to the shape of a facing outer side of the support structure.

7. A soft collision target in accordance with claim 1,
wherein the covering panel is attached to the support structure by at least one magnet.

8. A soft collision target in accordance with claim 1,
wherein a plurality of covering panels together form an outer cover of the soft collision target.

9. A soft collision target for trials with a possible vehicle collision comprising:
a support structure; and
at least one covering panel that is releasably connected to the support structure for replicating an outer shape of a collision target,
wherein the support structure has a plurality of struts of which at least one strut comprises at least two strut members arranged following one another in a longitudinal direction, and
wherein adjacent ends of two of said at least two strut members facing each other are braced against one another by an elastic tensioning means.

10. A soft collision target in accordance with claim 9,
wherein the strut members are hollow in an interior and the elastic tensioning means extends in the interior of the strut members.

11. A soft collision target in accordance with claim 9,
wherein one of the tensioning means is respectively fastened to a corresponding one opposing end of one of the at least two strut members, the corresponding one opposing end opposite the adjacent end of the respective one strut member.

12. A soft collision target in accordance with claim 9,
wherein a respective one adjacent end of the ends of the strut members comprises an elevated portion and the other end comprises a recess complementary to the elevated portion.

13. A soft collision target in accordance with claim 12,
wherein the elevated portion and the recess each have a passage for the elastic tensioning means extending in the longitudinal direction of the strut.

14. A soft collision target in accordance with claim 9,
wherein at least two strut members of a strut that are tensioned against one another are magnetically connected to one another at their ends that face one another.

15. A soft collision target in accordance with claim 9,
wherein two respective ends of the ends of the strut members that face one another have a magnet, said magnets attracting one another.

16. A soft collision target in accordance with claim 1, wherein the first layer comprises a polycarbonate material.

17. A soft collision target in accordance with claim 1, wherein the second layer is formed from a foamable plastic material.

18. A soft collision target in accordance with claim 1, wherein the second layer is formed from a polyurethane foam.
